(19) United States
(12) Patent Application Publication
(10) Pub. No.: US 2010/0039511 A1
(43) Pub. Date: Feb. 18, 2010

(54) Device of monitoring system and method thereof

(76) Inventor: Li-Hsing Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,758

(22) Filed: Aug. 15, 2008

(51) Int. Cl. H04N 7/18

(52) U.S. Cl. 348/143; 348/E07.085

(57) ABSTRACT

The present invention provides a device of a monitoring system and a method thereof. The device of the present invention includes a monitoring camera that includes at least one red light-emitting diode and contains motion detection monitoring camera therein and at least one auxiliary visible light source, cooperating with the method of the present invention that includes steps of monitoring and video-recording a monitored zone, detecting the monitored zone, activating an auxiliary visible light source, detecting the monitored zone, and de-activating the auxiliary visible light source. Whereby, with the least power consumption, images obtained in the nighttime can contain color contents as clear as those obtained in the daytime.

### FIELD OF THE INVENTION

The present invention relates to a device of a monitoring system and a method thereof. With the least power consumption, the present invention provides images of nighttime watching that are as colorful and clear as images of daytime watching. The present invention is particularly suitable for monitoring or watching in the nighttime or in poor lighting environment.

### BACKGROUND OF THE INVENTION

The conventionally known devices of nighttime monitoring systems, as well as methods thereof, must include auxiliary illumination lighting in order to obtain clear monitoring images, so that the device of the monitoring system can be assisted by the power lighting source to obtain images as clear as those obtained in the daytime. However, lighting in this way for a whole night takes up a great amount of power, and thus results in an increase of the operation costs of the device of the monitoring system. Another solution is to use red light-emitting diode (LED) as auxiliary lighting. This is effective in reducing the amount of power consumed, but using red LED as auxiliary lighting in the nighttime only allows a monitoring camera to obtain non-color images, which not only affects the quality of images obtained but also causes troubles in image recognition.

In view of such problems, the present invention is aimed to provide a solution to such problems.

### SUMMARY OF THE INVENTION

An objective of the present invention is to provide a device of a monitoring system and a method thereof. The present invention makes it possible, with the least power consumption, to have images obtained in nighttime monitoring as clear as those obtained in daytime monitoring so as to enhance the overall practicability and environment friendliness.

To realize the above objective, the present invention provides a device of a monitoring system and a method thereof. The device of the present invention comprises a monitoring camera that comprises at least one red light-emitting diode and contains motion detect means therein and at least one auxiliary visible light source, cooperating with the method of the present invention that comprises a sequence of cyclically executed steps which includes monitoring and video-recording a monitored zone, detecting the monitored zone, activating an auxiliary visible light source, detecting the monitored zone, and de-activating the auxiliary visible light source, whereby when the motion detect means of the monitoring camera determines that an object is entering the monitored zone, the auxiliary visible light source will be activated to illuminate the monitored zone and when the motion detect means of the monitoring camera determines that the object is leaving the monitored zone, the auxiliary visible light source will be turned off. Thus, with the least power consumption, images obtained in the nighttime can contain color contents and be as clear as those obtained in the daytime.

### BRIEF DESCRIPTION OF THE DRAWINGS

The present invention will be apparent to those skilled in the art by reading the following description of preferred embodiments thereof with reference to the drawings, in which:

FIG. 1 is a flow chart illustrating a method in accordance with the present invention;

FIG. 2 is a first schematic view illustrating the operation of the present invention;

FIG. 3 is a second schematic view illustrating the operation of the present invention;

FIG. 4 is a third schematic view illustrating the operation of the present invention;

FIG. 5 is a fourth schematic view illustrating the operation of the present invention; and

FIG. 6 is a perspective view illustrating a device in accordance with the present invention.

### DETAILED DESCRIPTION OF THE PREFERRED EMBODIMENT

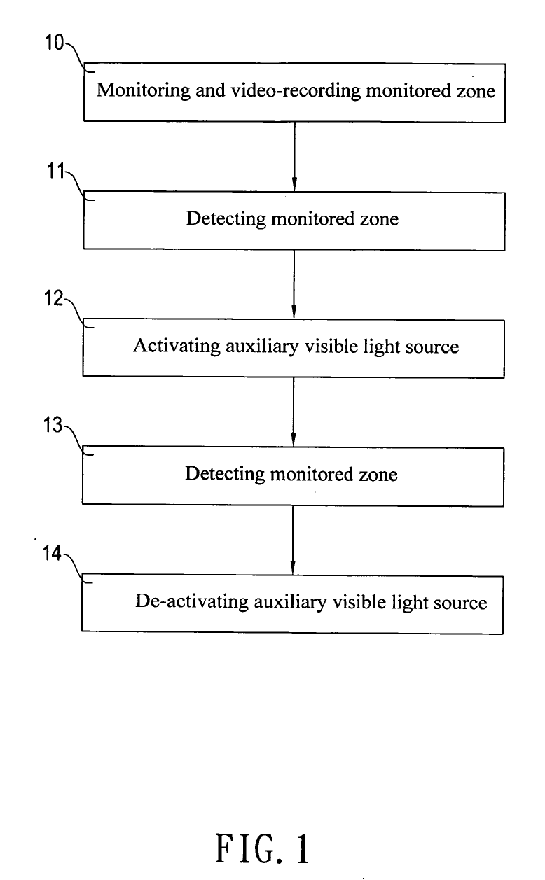

With reference to the drawings and in particular to FIG. 1, which shows a flow chart of the process in accordance with a method of the present invention, the method of the present invention comprises the following steps:

(a) Monitoring and video-recording monitored zone (step 10): A monitoring camera is provided to video-record a monitored zone and at least one red light-emitting diode (LED) (multiple red LEDs being provided in the present embodiment) is provided in the circumferential area around the lens of the monitoring camera so as to illuminate the monitored zone for video-recording of non-color images. That is, the monitoring camera provides a means for motion detection and image judgment;

(b) Detecting monitored zone (step 11): When an object enters the monitored zone, the motion detect means of the monitoring camera will make a judgment and issue an electronic signal;

(c) Activating auxiliary visible light source (step 12): An auxiliary visible light source receives the electronic signal issued by the monitoring camera so as to have the auxiliary visible light source activated to illuminate the monitored zone, allowing the monitoring camera to video-record images of color contents. The auxiliary visible light source can be constituted by high-brightness LEDs, power-saving fluorescent tubes or other lighting measures;

(d) Detecting monitored zone (step 13): When the object that entered the monitored zone leaves the monitored zone, the motion detect means of the monitoring camera makes a judgment and issues an electronic signal; and

(e) De-activating auxiliary visible light source (step 14): The auxiliary visible light source receives the electronic signal issued by the monitoring camera so as to have the auxiliary visible light source switched off.

When the red LED(s) of the monitoring camera gives off infrared light to illuminate the monitored zone, the motion detect means of the monitoring camera carries out comparison between images taken by the monitoring camera in two adjacent time axes to determine if an object (such as an automobile) enters the monitored zone. This is based on that when the infrared light emitting from the red LED, which is assumed to transmit through the monitored zone, is reflected by the object entering the monitored zone. Followed by judgment carried out by the motion detect means of the monitoring camera, the value of an electronic signal so obtained will change. An example is that when there is no object (such as an automobile) entering the monitored zone, the value of the electronic signal so obtained after the judgment carried out by the motion detect means of the monitoring camera is set to “0” (zero), and when an object (such as an automobile) gets into the monitored zone, the value of the electronic signal so obtained after the judgment made by the motion detect means of the monitoring camera will be changed to “1” (one). In this way, the monitoring camera makes a judgment if there is an object entering the monitored zone. The monitoring camera, at the time of issuing the electronic signal to activate/de-activate at least one auxiliary visible light source, simultaneously issues an electronic signal to correspondingly de-activate/activate the red LED. In other words, when the at least one auxiliary visible light source is activated, the red LED is de-activated correspondingly; when the at least one auxiliary visible light source is de-activated, the red LED is activated correspondingly, whereby power consumption can be reduced. (However, it is noted that, in actual application, the red LED can be set in a normally activated condition to constantly illuminate the monitored zone.) With such steps, images obtained in nighttime monitoring can be as clear as those obtained in daytime monitoring with the least power consumption.

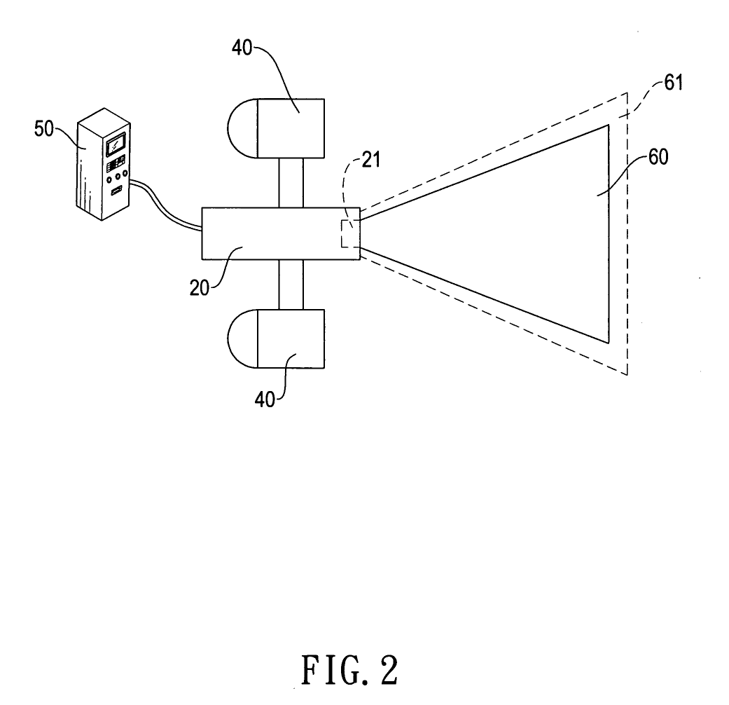

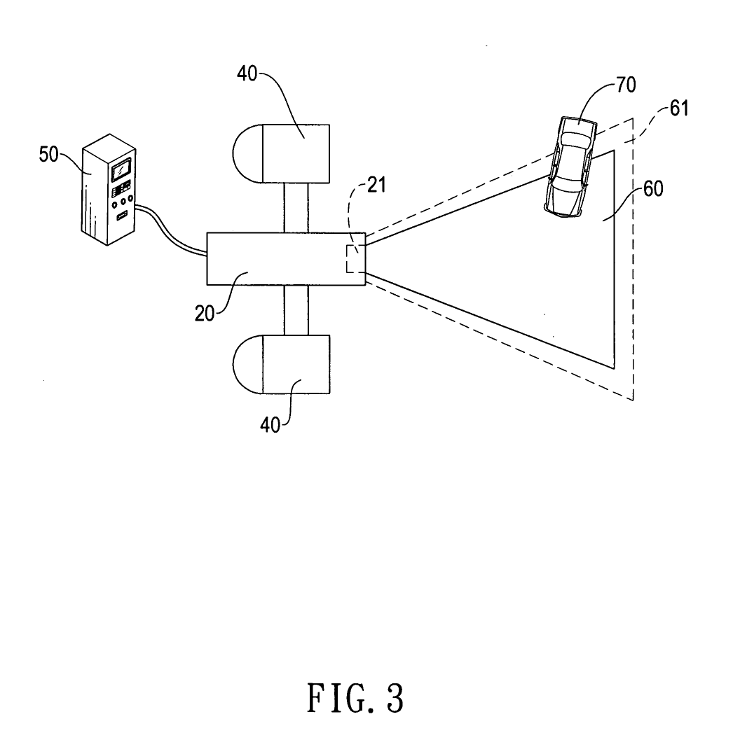

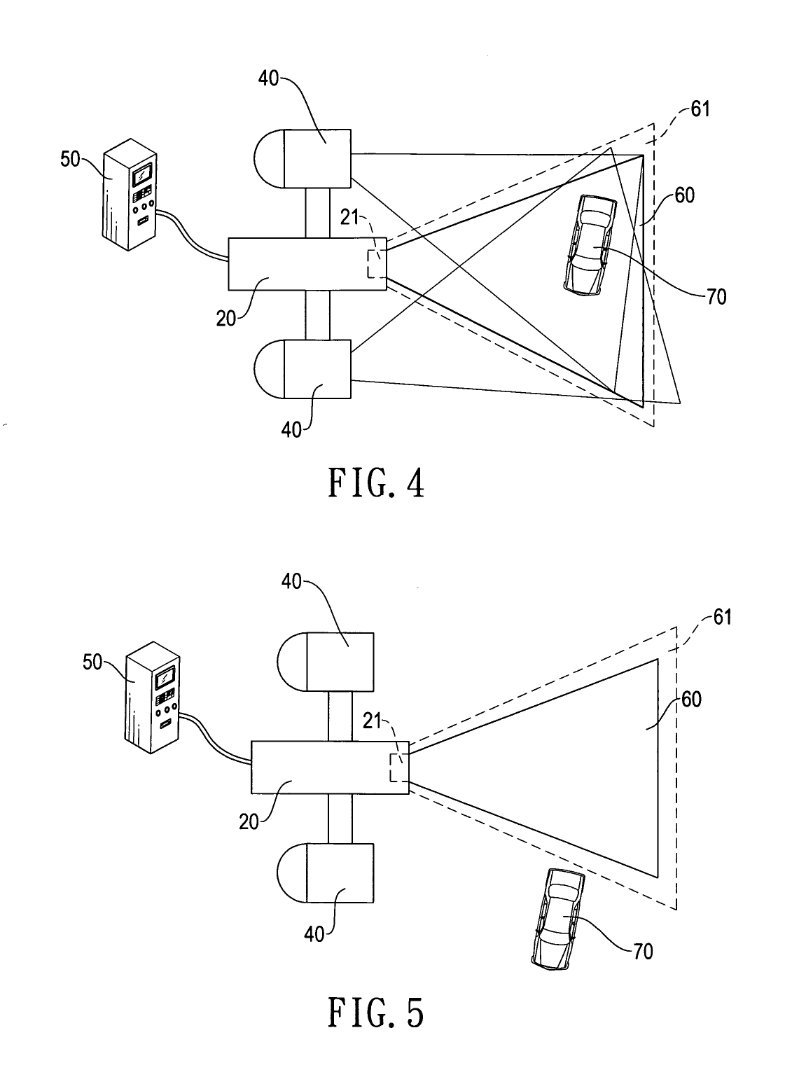

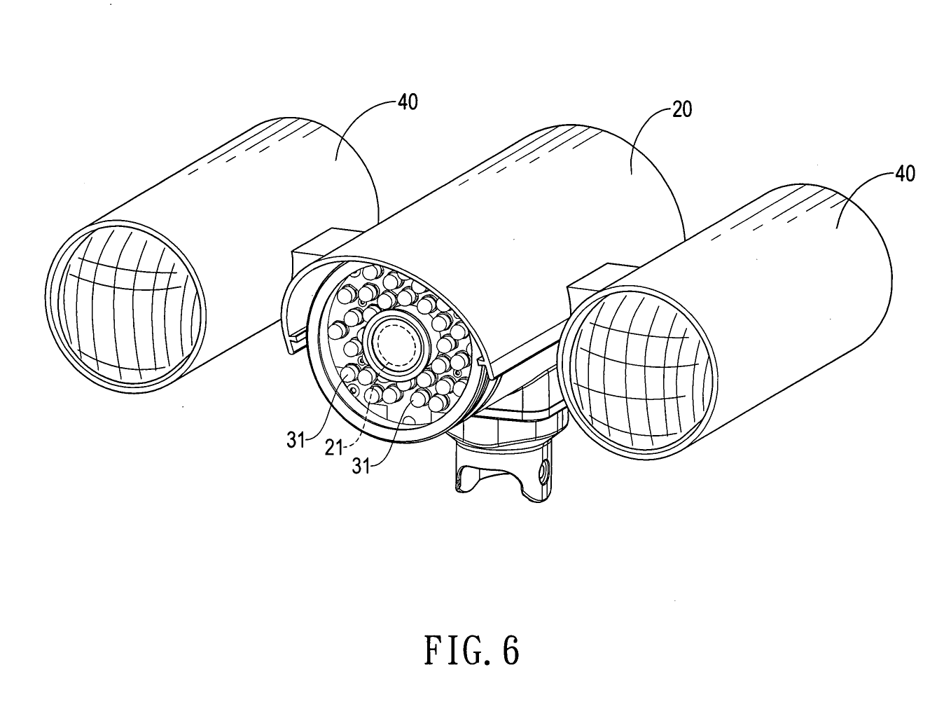

Referring to FIGS. 2-5, which schematically illustrate the operation of the present invention, the present invention can be employed to monitor a driveway in the nighttime by providing a monitoring camera 20 and at least one auxiliary visible light source 40. In the embodiment illustrated, two auxiliary visible light sources 40 are provided and the two auxiliary visible light sources 40 are respectively arranged at opposite sides of the monitoring camera 20. The monitoring camera 20 contains motion detect means 21 to allow the monitoring camera 20 to video-record and detect a monitored zone 60. The monitoring camera 20 is provided with at least one red LED 31 arranged in a circumferential area around a lens thereof. (In the embodiment illustrated, a plurality of red LEDs 31 is provided, as shown in FIG. 6.) The red LED 31, when activated, serves as an auxiliary light source for illuminating the monitored zone 60 to thereby form an infrared light illumination area 61 inside the monitored zone 60, whereby the monitoring camera 20 can obtain clear non-color images from the monitored zone 60 (as illustrated in FIG. 2) even in a poor lighting environment (such as in the nighttime). When the motion detect means 21 of the monitoring camera 20 determines that an object 70 (such as an automobile) entering the monitored zone 60 (as illustrated in FIG. 3), the monitoring camera 20 is caused to provide an electronic signal, making the at least one auxiliary visible light source 40 activated to illuminate the monitored zone 60 (as illustrated in FIG. 4) and thus allowing the monitoring camera 20 to video-record images with color contents and also issue an electronic signal to de-activate or shut down the red LED 31 for purposes of saving power consumption. When the motion detect means 21 of the monitoring camera 20 determines that the object 70 (such as an automobile) leaves the monitored zone 60 (as illustrated in FIG. 5), an electronic signal is generated to de-activate the at least one auxiliary visible light source 40 for saving power consumption and at the same time, activating the at least one red LED 31 to illuminate the monitored zone 60 and thereby forming an infrared light illumination area 61 in the monitored zone 60 to allow the monitoring camera 20 to video-record non-color images. As such, the steps may be repeated as desired.

Further, the monitoring camera 20 can be further connected to a storage device 50 and the storage device 50 is set in electrical connection with the monitoring camera 20 to receive and store the images obtained by video-recording the monitored zone 60 in files. In an actual application, the storage device 50 can be embodied to store the non-color images obtained from the monitored zone 60 for a long period of time, or alternatively, in the step (step 11) of detecting the monitored zone, at the same time when the motion detect means 21 of the monitoring camera 20 determines that an object 70 (such as an automobile) enters the monitored zone 60, the monitoring camera 20, besides being caused to issue an electronic signal to activate the auxiliary visible light source 40, also issues an electronic signal to activate the storage device 50 to store the images that the monitoring camera 20 video-records the monitored zone 60 and that contains color contents. Further, in the step (step 13) of detecting the monitored zone, the motion detect means 21 of the monitoring camera 20 determines that the object 70 (such as an automobile) leaves the monitored zone 60, the monitoring camera 20 issues an electronic signal to de-activate the at least one auxiliary visible light source 40 and activate the at least one red LED 31 for illuminating the monitored zone 60 and forming an infrared light illumination area 61 in the monitored zone 60 and at the same time, also stop the storage operation of the storage device 50 to reduce the need of storage capacity and to more fully exploit the resources available.

Referring to FIGS. 2-6, the device of monitoring system in accordance with the present invention comprises the following components:

A monitoring camera 20 functions to video-record a monitored zone 60 and the monitoring camera 20 comprises at least one red LED 31 arranged in a circumferential area around a lens thereof for illuminating the monitored zone 60 to carry out video-recording of non-color images. The monitoring camera 20 comprises motion detect means 21 for performing judgment of images and issuing an electronic signal. When at least one red LED 31 gives off infrared light to illuminate the monitored zone 60 and forms an infrared light illumination area 61 in the monitored zone 60, the motion detect means 21 of the monitoring camera 20 carries out comparison between images taken by the monitoring camera 20 in two adjacent time axes to determine if an object 70 (such as an automobile) enters the monitored zone 60. When an object 70 (such as an automobile) enters the monitored zone 60, the infrared light emitting from the at least one red LED 31 radiates on and is reflected by the object 70 (such as an automobile), followed by judgment carried out by the motion detect means 21 of the monitoring camera 20, the value of the electronic signal so obtained will change. An example is that when there is no object 70 (such as an automobile) entering the monitored zone 60, the value of the electronic signal so obtained after the judgment carried out by the motion detect means 21 of the monitoring camera 20 is set to “0” (zero), and when an object 70 (such as an automobile) gets into the monitored zone 60, the value of the electronic signal so obtained after the judgment made by the motion detect means 21 of the monitoring camera 20 will be changed to “1” (one). In this way, the monitoring camera 20 makes a judgment if there is an object 70 entering the monitored zone 60.

At least one auxiliary visible light source 40 is in electrical connection with the monitoring camera 20 and the auxiliary visible light source 40 receives the electronic signal issued by the monitoring camera 20 to activate/de-activate the light source to allow the monitoring camera 20 to obtain images that contain color contents. The at least one auxiliary visible light source 40 can be for example high-brightness LEDs, power-saving fluorescent tubes or other lighting measures. As such, the device of the present invention can obtain mages in nighttime monitoring that are as clear as those obtained in daytime monitoring, but with the least consumption of power.

The monitoring camera 20, at the time of issuing an electronic signal to activate/de-activate the at least one auxiliary visible light source 40, further issues an electronic signal to correspondingly de-activate/activate the at least one red LED 31. (However, it is noted that, in an actual application, the at least one red LED 31 can also be set in a normally activated condition for constantly illuminating the monitored zone 60.) The monitoring camera 20 can be further connected to a storage device 50 in such a way that the storage device 50 is in electrical connection with the monitoring camera 20 to receive and store the images obtained by video-recording the monitored zone 60 in files. In an actual application, the storage device 50 can be embodied to store the non-color images obtained from the monitored zone 60 for a long period of time, or alternatively, the storage device 50 can be embodied in such a way that only the images that are clear and contain color contents obtained at the time when the motion detect means 21 of the monitoring camera 20 determines that an object 70 (such as an automobile) enters the monitored zone 60 and the at least one auxiliary visible light source 40 is activated are stored in order to reduce the need of storage capacity and to enhance the utilization efficiency of the resources available.

With reference to FIGS. 1-6, the features of the device of monitoring system in accordance with the present invention and the method thereof are as follows: With a combination of a monitoring camera 20 and at least one auxiliary visible light source 40 and further with at least one red LED 31 arranged in a circumferential area around the lens of the monitoring camera 20 to serve as an auxiliary light source, the light emitting from the red LED 31 forms an infrared light illumination area 61 covering a monitored zone 60 so that the monitoring camera 20 is allowed to obtain images that are clear but non-color in the nighttime (or in an environment of poor lighting). The motion detect means 21 provided in the monitoring camera 20 can make judgment of the images and issues an electronic signal to activate/de-activate at least one auxiliary visible light source 40, and the at least one auxiliary visible light source 40 can be high-brightness LEDs, power-saving fluorescent tubes, or other lighting measures, whereby the monitoring camera 20 is allowed to video-record images that are clear and contain color contents in the nighttime (or in an environment of poor lighting). Further, the device in accordance with the present invention, together with a sequence of steps of monitoring and video-recording monitored zone (step 10), detecting monitored zone (step 11), activating auxiliary visible light source (step 12), detecting monitored zone (step 13), and de-activating auxiliary visible light source (step 14) in accordance with the present invention, images that are obtained in the nighttime can contain color contents and be as clear as those obtained in the daytime but with the least consumption of power. The monitoring camera 20 can be further connected to a storage device 50 and the storage device 50 can be embodied in such a way that only the images that are clear and contain color contents obtained by video-recording of the monitored zone 60 at the time when the motion detect means 21 of the monitoring camera 20 determines that an object 70 (such as an automobile) enters the monitored zone 60 in order to reduce the need of storage capacity and to enhance the utilization efficiency of the resources available. Thus, from the above description, it is noted that the present invention features power-saving, environment protection, and enhancing of utilization efficiency of resources, and thus possesses practicability and environment friendliness.

Although the device and method of the present invention were described above with respect to an example of monitoring a driveway in the nighttime, yet it is noted that the present invention is not limited to the application of nighttime monitoring of a driveway and can also be used in the daytime of bad weather or in other poor lighting situations.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A device of a monitoring system, comprising:
a monitoring camera, which serves to carry out video-recording of a monitored zone, the monitoring camera comprising at least one red light-emitting diode arranged in a circumferential area around the lens thereof for illuminating the monitored zone to carry out video-recording of non-color images, the monitoring camera comprising motion detect means for performing judgment of images and issuing an electronic signal; and
at least one auxiliary visible light source, which is in electrical connection with the monitoring camera, the auxiliary visible light source receiving the electronic signal issued by the monitoring camera to activate/de-activate the light source to allow the monitoring camera to obtain images that contain color contents;
whereby images obtained in nighttime monitoring can be as clear as those obtained in daytime monitoring, but with the least consumption of power.

2. The device as claimed in claim 1, wherein the auxiliary visible light source comprises a high-brightness light-emitting diode, a power-saving fluorescent tube or other lighting measures.

3. The device as claimed in claim 1, wherein the monitoring camera is further connected to a storage device for receiving and storing the images obtained by video-recording the monitored zone in files.

4. The device as claimed in claim 1, wherein the monitoring camera, when issuing the electronic signal to activate/de-activate the at least one auxiliary visible light source, simultaneously issues an electronic signal to correspondingly de-activate/activate the at least one red light-emitting diode.

5. A method for a monitoring system comprising the following steps:
(a) monitoring and video-recording monitored zone, wherein a monitoring camera is provided to video-record a monitored zone and the monitoring camera is provided, in a circumferential area around a lens thereof, with at least one red light-emitting diode to illuminate the monitored zone for video-recording of non-color images, the monitoring camera being provided therein with motion detect means to perform judgment on images;
(b) detecting monitored zone, wherein when an object enters the monitored zone, the motion detect means of the monitoring camera makes a judgment and issues an electronic signal;
(c) activating auxiliary visible light source, wherein an auxiliary visible light source receives the electronic signal issued by the monitoring camera so as to have the auxiliary visible light source activated to illuminate the monitored zone, allowing the monitoring camera to video-record images of color contents;
(d) detecting monitored zone, wherein when the object that entered the monitored zone leaves the monitored zone, the motion detect means of the monitoring camera makes a judgment and issues an electronic signal; and
(e) de-activating auxiliary visible light source, wherein the auxiliary visible light source receives the electronic signal issued by the monitoring camera so as to have the auxiliary visible light source de-activated;
whereby with such steps, images obtained in nighttime monitoring can be as clear as those obtained in daytime monitoring, but with the least consumption of power.

6. The method as claimed in claim 5, wherein the auxiliary visible light source comprises a high-brightness light-emitting diode, a power-saving fluorescent tube or other lighting measures.

7. The method as claimed in claim 5, wherein the monitoring camera is further connected to a storage device for receiving and storing the images obtained by video-recording the monitored zone in files.

8. The method as claimed in claim 5, wherein the monitoring camera, when issuing the electronic signal to activate/de-activate the auxiliary visible light source, simultaneously issues an electronic signal to correspondingly de-activate/activate the at least one red light-emitting diode.
